(19) United States
(12) Patent Application Publication
(10) Pub. No.: US 2026/0209442 A1
(43) Pub. Date: Jul. 23, 2026

(54) DUAL CURE ORGANOPOLYSILOXANE COMPOSITION WITH SHELF-LIFE STABILITY

(71) Applicant: DOW SILICONES CORPORATION, Midland, MI (US)

(72) Inventor: Jong-Ok LIM, Chungcheongbuk-Do (KR)

(21) Appl. No.: 19/142,192

(22) PCT Filed: Dec. 19, 2023
(86) PCT No.: PCT/KR2023/020941

§ 371 Date: Jun. 21, 2025

(30) Foreign Application Priority Data
Dec. 23, 2022 (KR) 10-2022-0182777

(51) Int. Cl. C08G 77/20; C08G 77/04; C08G 77/18; C08G 77/28; C09D 183/08; C09J 183/08

(52) U.S. Cl. CPC C08G 77/20; C08G 77/045; C08G 77/18; C08G 77/28; C09D 183/08; C09J 183/08

(57) ABSTRACT

This disclosure provides a dual curable organopolysiloxane composition which has the ability to both photo-cure and cure through exposure to moisture, and which exhibits excellent curability and long-term storage stability at room temperature or ambient storage condition and can be applied in solventless-form. A dual cure organopolysiloxane composition comprises: (A) an organopolysiloxane having an average of one or more alkenyl group(s) per molecule and an average of one or more hydrolysable group(s) per molecule; (B) an organopolysiloxane having an average of two or more photoreactive groups per molecule; (C) a condensation reaction catalyst; (D) a combination of the following photoinitiators (d1) to (d3); (d1) 2,4,6-trimethylbenzoylphenyl phosphinate, (d2) bis(2,4,6-trimethylbenzoyl)-phenylphosphine oxide, and (d3) 2,2-dimethoxy-1,2-diphenylethan-1-one; (E) a silane with an average of two or more hydrolysable groups per molecule; and, optionally, (F) a radical scavenger.

### TECHNICAL FIELD

The present invention relates to an organopolysiloxane composition capable for both ultra-violet (UV) and moisture induced curing. In particular, the organopolysiloxane composition is superior in its shelf-life stability and preferred to use as solventless-type composition which is substantively free from using organic solvent.

### BACKGROUND ART

Since dual curable organopolysiloxane compositions using UV light and moisture curing mechanisms brings the benefit of instant cure through UV primary cure and moisture cure for secondary shadow area curing, its application in electronic articles are spreading.

For example, dual curable organopolysiloxane composition are disclosed in Patent Document 1. This reference discloses compositions particularly useful for conformal coatings in electronic applications where the substrate has shadow areas which are not readily accessible to direct UV light and require moisture cure for cross-linking of those areas. Ordinarily, in addition to the photo-initiator present for radiation polymerization, a condensation catalyst such as an organotitanate or organotin is present. Without the condensation catalyst, moisture cure does not ordinarily take place with any degree of certainty or in any predictable time frame. Thus, as a practical matter, without the condensation catalyst, the moisture curing aspect of these compositions would not be practical for commercial use. Furthermore, this composition is lacking of storage stability at room temperature or ambient storage condition.

In similar, solvent-type dual curable organopolysiloxane compositions are proposed in Patent Documents 2 and 3. Thiol-ene reaction by UV irradiation and moisture cure reaction by alkoxy condensation with titanium catalyst provide good cure performance and physical property at fresh state. However, it requires low temperature or freezer condition storage during its shelf life in order to maintain its cure performance and property. This specific low temperature storage condition is good for maintaining its performance, but it provides other limitation such as storage cost increase and additional investment to manufacturer and user with negative sustainability. Furthermore, these compositions cannot be applied for solventless-type composition and coating/adhesive applications.

Thiol-ene-based UV and moisture dual cure systems tend to suffer from relatively short shelf-life compared with moisture-cure only systems or thiol-ene UV cure only siloxane systems. Shelf-life can be evaluated by determining if a composition experiences an increase in viscosity and/or decrease in cure depth upon UV cure and/or increase in time to tack-free surface by moisture curing after storage relative to when the composition is freshly made.

Patent Documents 4 and 5 attempts to address the problem of shelf-life for thiol-ene based dual cure formulations by providing a thiol-ene dual cure organopolysiloxane system that requires an epoxy compound to stabilize the formulation.

However, dual curable organopolysiloxane compositions disclosed in aforementioned patent documents are lack of long-term storage stability and shelf-life at room temperature or ambient storage condition. Furthermore, it would be desirable to provide a solventless-type (i.e. substantively free from using organic solvents) dual UV-curable, moisture-curable silicone composition where cure of the composition by UV results in a coating that is dry to the touch without the common tacky surface often associated with an acrylate cure.

### PRIOR ART DOCUMENTS

### Patent Documents

Patent Document 1: U.S. Pat. No. 4,528,081
Patent Document 2: U.S. Pat. No. 6,828,355
Patent Document 3: WO2006/060189 A2
Patent Document 4: WO2019/005393 A1
Patent Document 5: WO2020/076620 A1

### DISCLOSURE OF INVENTION

### Technical Problem

An object of the present invention is to provide a dual curable organopolysiloxane composition which has the ability to both photo-cure and cure through exposure to moisture, and which exhibits excellent curability and long-term storage stability at room temperature or ambient storage condition and preferred to be applied in sol-ventless-form.

### Solution to Problem

As a result of intensive investigation, the present inventors have found that the problems described above can be resolved by a dual cure organopolysiloxane composition comprising:
(A) an organopolysiloxane having an average of one or more alkenyl group per molecule and an average of one or more hydrolysable group per molecule;
(B) an organopolysiloxane having an average of two(2) or more photoreactive group per molecule;
(C) a condensation reaction catalyst;
(D) a combination of following photoinitiators (d1) to (d3);
(d1) 2,4,6-trimethylbenzoylphenyl phosphinate,
(d2) bis(2,4,6-trimethylbenzoyl)-phenylphosphine oxide, and
(d3) 2,2-dimethoxy-1,2-diphenylethan-1-one,
(E) a silane with an average of 2 or more hydrolysable groups per molecule; and, optionally,
(F) a radical scavenger.

In various embodiments, the mass ratio for said component (d1) to (d3) is within the following ranges when the total mass of component (d1) to (d3) is 100% by mass:
the mass ratio for component (d1) ranges from 10 to 30 mass % by mass,
the mass ratio for component (d2) ranges from 20 to 40 mass % by mass, and
the mass ratio for component (d3) ranges from 40 to 80 mass % by mass.

In certain embodiments, the composition results from both a UV-radiation cure mechanism and a moisture cure mechanism.

In certain embodiments, the composition is substantively free from organic solvents, i.e. “solventless-type” composition.

In certain embodiments, the composition is for use as a potting (or a pottant), a coating, an adhesive, or an encapsulation.

### Advantageous Effects of Invention

The dual curable organopolysiloxane composition according to this disclosure generally has the ability to both photo-cure and cure through exposure to moisture, and exhibits good to excellent curability and long-term storage stability at room temperature or ambient storage condition. Furthermore, the present composition can be easily applied in “solventless-type” composition form having excellent coating ability and appropriate viscosity.

### MODE FOR THE INVENTION

The terms “comprising” or “comprise” are used herein in their broadest sense to mean and encompass the notions of “including,” “include,” “consist(ing) essentially of,” and “consist(ing) of.” The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and/or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### <Dual Curable Organopolysiloxane Composition>

Component (A) is an organopolysiloxane having an average of one or more alkenyl group per molecule and an average of one or more hydrolysable group per molecule. Examples of the alkenyl group include vinyl groups, allyl groups, butenyl groups, pentenyl groups, hexenyl groups, heptenyl groups, octenyl groups, nonenyl groups, decenyl groups, undecenyl groups, and dodecenyl groups. In certain embodiments, from the perspective of economics and reactivity, at least one of vinyl groups, allyl groups, hexenyl groups, and octenyl groups are present. In particular, in view of the excellent curability of the composition by UV light, component (A) may have at least two alkenyl groups per molecule.

Examples of the hydrolysable group include alkoxy group like methoxy groups, ethoxy groups, propoxy groups, and butoxy groups. In certain embodiments, from the perspective of economics and curability, at least one of methoxy groups and ethoxy groups are present. In particular, in view of the excellent curability of the composition by moisture, component (B) may have at least two silicon atom-bonded alkoxy groups per molecule.

Furthermore, examples of groups other than alkenyl groups and alkoxy groups that are bonded to the silicon atom in component (A) include: alkyl groups with 1 to 12 carbons such as methyl groups, ethyl groups, propyl groups, butyl groups, pentyl groups, hexyl groups, heptyl groups, octyl groups, nonyl groups, decyl groups, undecyl groups, dodecyl groups, and the like; aryl groups with 6 to 12 carbons such as phenyl groups, tolyl groups, xylyl groups, and the like; aralkyl groups with 7 to 12 carbons such as benzyl groups, phenetyl groups, and the like; halogen substituted alkyl groups with 1 to 12 carbons such as 3-chloropropyl groups, 3,3,3-trifluoropropyl groups, and the like. In certain embodiments, from the perspective of economics and heat resistance, methyl groups are present.

Component (A) may be produced by a hydrosilation reaction of (A-1) an organopolysiloxane having at least two alkenyl groups per molecule and (A-2) an organosilicon compound having one silicon atom-bonded hydrogen atom and at least one silicon atom-bonded hydrolysable (i.e. alkoxy) group per molecule.

Component (B) is an organopolysiloxane having an average of two(2) or more photoreactive group per molecule. As said photoreactive group, mercapto (—SH) functional groups is most preferred. Examples of the mercapto functional groups include mercaptoalkyl groups such as 3-mercaptopropyl groups, 4-mercaptobutyl groups, and 6-mercaptohexyl groups. Furthermore, examples of groups other than mercapto functional groups that are bonded to the silicon atom in component (A) include: alkyl groups with 1 to 12 carbons such as methyl groups, ethyl groups, propyl groups, butyl groups, pentyl groups, hexyl groups, heptyl groups, octyl groups, nonyl groups, decyl groups, undecyl groups, dodecyl groups, and the like; aryl groups with 6 to 12 carbons such as phenyl groups, tolyl groups, xylyl groups, and the like; aralkyl groups with 7 to 12 carbons such as benzyl groups, phenetyl groups, and the like; halogen substituted alkyl groups with 1 to 12 carbons such as 3-chloropropyl groups, 3,3,3-trifluoropropyl groups, and the like. In certain embodiments, from the perspective of economics and heat resistance, methyl groups are present. Furthermore, the silicon atom in component (B) may be bonded to a small amount of hydrogen atoms, hydroxyl groups or alkoxy groups such as methoxy groups, ethoxy groups, n-propoxy groups, i-propoxy groups, n-butoxy groups, sec-butoxy groups, tert-butoxy groups and the like.

In various embodiments, component (B) is an organopolysiloxane comprising at least two siloxane units of the following general formula:

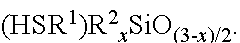

In the formula, R¹ represents a divalent hydrocarbon group. Examples of the divalent hydrocarbon groups include: alkylene groups with 1 to 8 carbons such as methylene groups, ethylene groups, propylene groups, butylene groups, pentylene groups, hexylene groups, heptylene groups, and octylene groups. In certain embodiments, from the perspective of economics and heat resistance, propylene groups are present.

In the formula, R² represents an alkyl group, an aryl group, a hydrogen atom, a hydroxyl group or an alkoxy group. Examples of R² include: alkyl groups with 1 to 12 carbons such as methyl groups, ethyl groups, propyl groups, butyl groups, pentyl groups, hexyl groups, heptyl groups, octyl groups, nonyl groups, decyl groups, undecyl groups, dodecyl groups, and the like; aryl groups with 6 to 12 carbons such as phenyl groups, tolyl groups, xylyl groups, and the like; alkoxy groups with 1 to 6 carbons such as methoxy groups, ethoxy groups, propoxy groups, and the like. In certain embodiments, from the perspective of economics and heat resistance, methyl groups are present.

In the formula, “x” is 0, 1 or 2. When “x” is 0, the siloxane unit is a T unit represented by the following general formula:

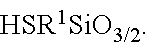

When “x” is 1, the siloxane unit is a D unit represented by the following general formula:

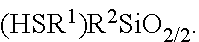

When “x” is 2, the siloxane unit is an M unit represented by the following general formula:

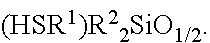

Such component (B) may have mercapto (—SH) groups in the range of from about 0.5 to about 15.0 mass %, optionally of from about 0.5 to about 10.0 mass %, optionally of from about 1.0 to about 15.0 mass %, optionally of from about 1.0 to about 10.0 mass %, optionally of from about 1.0 to about 5.0 mass %, or optionally of from about 1.0 to about 4.0 mass %, of the component. This is because, if the content is above the lower limit of the range, curability of the composition obtained will be enhanced; however, on the other hand, if the content is below the upper limit of the aforementioned range, heat resistance of the cured product obtained will be enhanced.

An average number of said photoreactive groups like mercapto (—SH) groups in component (B) is two(2) or more, and preferred to be from two(2) to ten(10). Most preferably, component (B) have three(3) to eight(8) of mercapto (—SH) groups in average.

Component (C) is a condensation reaction catalyst to enhance moisture cure of the composition. Examples of component (C) include organo-metal catalysts (typically a titanate, tin or zirconium based catalyst) including titanium compounds such as tetra(isopropoxy)titanium, tetra(n-butoxy)titanium, tetra(t-butoxy)titanium, di(isopropoxy)bis(ethylacetoacetate)titanium, di(isopropoxy)bis(methylacetoacetate)titanium, di(isopropoxy)bis(acetylacetonate)titanium, and the like; zirconium compounds such as tetra(isopropoxy)zirconium, tetra(n-butoxy)zirconium, tetra(t-butoxy)zirconium, di(isopropoxy)bis(ethylacetoacetate)zirconium, di(isopropoxy)bis(methylacetoacetate)zirconium, di(isopropoxy)bis(acetylacetonate)zirconium, and the like; tin compounds such as dimethyltin dineodecanoate, dibutyltin dilaurate, dibutyltin dioctoates, and the like; and stannous octoate, and the like. The condensation catalyst is typically a titanate, tin or zirconium based catalyst. Examples of suitable condensation catalysts include any one or any combination of more than one condensation catalyst selected from a group consisting of tetraisopropylorthotitanate, titanium (IV) n-butoxide, titanium (IV) t-butoxide, titanium (IV), titanium di(isopropoxy)bis(ethylacetoacetate), Tetrakis(trimethylsiloxy)titanium; titanium di(isopropoxy)bis(methylacetoacetate), zirconium (IV) isopropoxide, zirconium (IV) n-butoxide, zirconium (IV) t-butoxide, zirconium di(isopropoxy)bis(ethylacetoacetate), zirconium di(isopropoxy)bis(methylacetoacetate), zirconium di(isopropoxy)bis(acetylacetonate, dimethyltin dineodecanoate, dibutyltin dilaurate, dibutyltin dioctoates, and stannous octoate.

The content of component (C) is in effective amount for moisture cure. In various embodiments, component (C) is present in an amount of from about 0.01 to about 10 parts by mass, optionally of from about 0.05 to about 10 parts by mass, or optionally of from about 0.05 to about 5 parts by mass, per 100 parts by the total mass of components (A) to (F). This is because if the amount of component (C) is above the lower limit of the range, the composition obtained will sufficiently cure by moisture; and if the amount is below the upper limit of the aforementioned range, surface cure rate of the resulting composition is improved.

Component (D) is one of most characteristic feature of this invention, and limited combination of following photoinitiators (d1) to (d3);
(d1) 2,4,6-trimethylbenzoylphenyl phosphinate,
(d2) bis(2,4,6-trimethylbenzoyl)-phenylphosphine oxide, and
(d3) 2,2-dimethoxy-1,2-diphenylethan-1-one.

Component (D) is limited combination of photoinitiators (d1) to (d3) to enhance photocuring reaction of the composition, and also exhibits good to excellent curability and long-term storage(=shelf-life) stability in the entire composition at room temperature or ambient storage condition. Also, said limited combination of photoinitiators is preferred to be easily and homogeneously soluble without using other organic solvent. Thus, through using said limited combination of photoinitiators (d1) to (d3), “sol-ventless-type” dual curable organopolysiloxane composition can be easily formulated. On the other hand, in case when any one of said component (d1) to (d3) is lacking from the composition, any of the benefits of superior curability, long-term storage(=shelf-life) stability and good compatibility in solventless-form composition will be impaired in the composition.

In various embodiments, the mass ratio for said component (d1) to (d3) is within the following ranges when the total mass of component (d1) to (d3) is 100% by mass:
the mass ratio for component (d1) ranges from 10 to 30 mass % by mass,
the mass ratio for component (d2) ranges from 20 to 40 mass % by mass, and
the mass ratio for component (d3) ranges from 40 to 80 mass % by mass.

The content of component (D) is in effective amount for photo-cure. In various embodiments, component (D) is present in an amount of from about 0.01 to about 5 parts by mass, optionally of from about 0.1 to about 5 parts by mass, or optionally of from about 0.1 to about 3 parts by mass, per 100 parts by the total mass of components (A) to (F). This is because if the amount of component (D) is above the lower limit of the range, the composition obtained will sufficiently cure by UV light; however, if, on the other hand, the amount is below the upper limit of the aforementioned range, the mechanical properties of the cured product obtained will be enhanced.

In preferred embodiments, the composition does not substantially contain other photoinitiators than said component (D). Specifically, the composition is preferred not to contain other photoinitiators than said component (D) in an amount of 0.1 parts or more by mass per 100 parts by the total mass of components (A) to (F). The content of other photoinitiators than said component (D) is preferred to be 0.01 parts or less by mass per 100 parts by the total mass of components (A) to (F), and most preferred to be below its detection limit.

Component (E) is a silane with an average of 2 or more hydrolysable groups per molecule to serves as a crosslinker. It can also serve as a carrier liquid and/or a reactive diluent. Desirably, the hydrolysable groups are alkoxy groups, more preferably the hydrolysable groups are alkoxy groups selected from a group consisting of methoxy, ethoxy, propoxy and butoxy. The silane can be a dialkoxy silane, a trialkoxy silane or a combination of dialkoxy and trialkoxy silanes. Most preferably, the silane is a trialkoxy silane.

The silane desirably has the following structure:

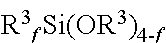

where subscript f is one, two or three (preferably one or two, most preferably one) and R³ is independently in each occurrence selected from a group consisting of methyl, ethyl, propyl and butyl groups. Examples of suitable silane compounds include any one or combination of more than one selected from methyltrimethoxy silane, ethyltriethoxy silane, and dimethyldimethoxy silane.

The content of component (E) is in effective amount to serve as a crosslinker. In various embodiments, component (E) is present in an amount of from about 0.01 to about 10 parts by mass, optionally of from about 0.05 to about 10 parts by mass, or optionally of from about 0.05 to about 5 parts by mass, per 100 parts by mass of the sum of components (A) to (F). This is because if the amount of component (E) is above the lower limit of the range, the composition obtained will have sufficient curing speed and curing property.

Optionally, to enhance or improve the long-term stability of the composition, in combination with said component (E) or at least in partially replacement with component (E), epoxy functional organosilicon compounds can be formulated into the composition. Examples of epoxy functional organosilicon compounds includes 3-glycidoxypropyl trimethoxysilane, 3-glycidoxypropyl triethoxysilane, 3-glycidoxypropyl methyldimethoxysilane, 2-(3,4-epoxycyclohexyl)ethyl trimethoxysilane, 2-(3,4-epoxycyclohexyl)ethyl methyldimethoxysilane, 3,4-epoxybutyl trimethoxysilane, 3,4-epoxybutyl methyldimethoxysilane, 5,6-epoxyhexyl trimethoxysilane, 5,6-epoxyhexyl triethoxysilane, 8-glycidoxyoctyl trimethoxysilane, and the like; and epoxy functional non-silicon compounds such as methyl glycidyl ether, glycidyl methacrylate, and the like.

Optionally, as component (F), the composition further comprises a radical scavenger (inhibitor) to inhibit radical reactions during storage to help increase storage stability of the composition. Examples of suitable radical scavengers include any one or any combination of more than one of butylated hydroxytoluene (BHT), 4-methoxyphenol, and tert-butylhydroquinone, 6-tert-butyl-2,4-xylenol, 2-tert-butyl-1,4-benzoquinone, 4-tert-butylpyrocatechol, 2,6-di-tert-butylphenol, and N-Nitroso-N-phenylhydroxyamine Aluminum salt.

The content of said component (F) is NOT limited, but is typically present at a concentration of 0.001 mass % or more, 0.01 mass % or more, 0.05 mass % or more, 0.50 mass % or more, 1.0 mass % or more while at the same time is typically present at a concentration of 2.0 mass % or less, 1.5 mass % or less, 1.0 mass % or less based on the entire composition weight.

The composition may also contain one or more other additives so long as they do not interfere with the curing mechanisms. For example, conventional additives such as fillers, adhesion promoters, resins, pigments, moisture scavengers, fluorescent dye, inhibitors and the like may be included.

Fillers such as fumed silica or quartz are contemplated. Fillers may be present in amounts up to about 30 mass %, such as from about 4 to about 20 mass % of the total mass of components (A) to (F).

Inhibitors may be present in amounts up to about 5% by weight, such as from about 0.001 to about 1 mass % of the total mass of components (A) to (F). The particular amount of inhibitor should be balanced in a given composition to produce or improve stability of the composition. Such amounts can be determined via routine experimentation.

Adhesion promoters may be present in amounts up to about 5 mass %, such as from about 0.5 mass % of the total mass of components (A) to (F).

[Solventless Form] The composition is preferred to “solventless”-type. Preferably, the composition is substantively free from organic solvents, and the preferred content of organic solvent is 1.0 mass % or less to the entire composition, and most preferably be below its detection limit. The example of said organic solvent includes, but not limited to, toluene, xylene, alcohols, and liquid alkanes, and other low-viscosity or volatile silicone oils.

The composition may be prepared by mixing together the respective components to obtain a substantially homogenous or uniformly blended material and stored in containers which are non-transmissive to UV light and moisture. Generally, a single package system is utilized, but two-part package systems may be used if desired. Whereas single package products are ready-for-use upon being dispersed, two-part systems generally require mixing of the dispersed parts prior to use.

The composition may be used as noted above in potting applications and coatings, encapsulations, gels for a variety of substrates including electronic parts and other heat-sensitive materials.

Useful UV radiation sources include conventional mercury-vapor lamps designed to emit ultraviolet energy in various ultraviolet wavelength bands, LED curing lamps, etc. For example, useful radiation wavelength ranges include 200 to 400 nm.

UV cure is generally effected in the range of 40 milliwatts/cm² (“mW/cm²”) to about 300 mW/cm², such as in the range of about 70 mW/cm² to about 300 mW/cm².

### EXAMPLES

The dual cure organopolysiloxane composition of the present invention will now be described in detail using Practical and Comparative Examples. The sample aging was conducted by storing the evaluation samples in 50° C. oven for two weeks for accelerated aging. The UV cure was conducted by exposing the 1 to 2 mm thickness sample to UV LED lamp (Phoseon FireJet™ FJ800) at 5 J/cm² of 405 nm or 395 nm. For additional exposure to UV LED 365 nm, the sample was additionally exposed for 1 to 3 J/cm². The measurements are as follows.

### <UV Cure Depth Measurement>

Samples are filled into 8 mm diameter and 7 mm depth PE JIG. After filling, sample is exposed to 10 J/cm² of 405 nm or 395 nm UV LED lamp. The cured thickness is then measured by thickness gage meter after removed from JIG. The threshold of this property is 5 mm, i.e., >5 mm.

### <Skin Over Time (Moisture Cure Rate)>

Sample is placed UV light free area at 22±2° C. and/50% RH+/−10% and then smoothly touch surface by finger every 5 to 10 min. The time period that nothing is on finger during touch is then measured. The threshold of this property is 12 hours, i.e., <12 hrs.

### <Shore A Hardness Test>

Once the sample is cured by UV exposure, it makes around >8 mm thickness by stacking and the Shore A hardness is then measured by Shore A hardness tester. After completion, this tested sample is cured for 3 days at ambient condition for moisture secondary cure and the Shore A hardness is then measured by the same manner. The threshold of the Shore A hardness difference before and after 14 days aging is 40%, i.e., <40%.

### <Viscosity Measurement>

Sample viscosity is measured using a Brookfield HADVIII cone and plate viscometer with spindle CPA-52Z at 5 rpm and 23±2° C. The threshold of the viscosity difference before and after 14 days aging is 30%, i.e., <30%.

### Practical Examples 1-5 and Comparative Examples 1-7

The following components were used to prepare dual cure organopolysiloxane compositions (mass %) shown in Table 1.

The following organopolysiloxane were used as component (A).
(a1): vinyl and alkoxysilyl functional dimethylpolysiloxane having the chemical structure:

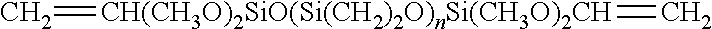

(a2): vinyl and alkoxysilyl functional dimethylpolysiloxane having the chemical structure:

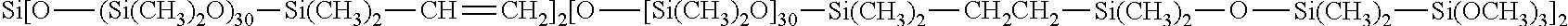

The following organopolysiloxane was used as component (B).
(b1): dimethylsiloxane methyl(3-mercaptopropyl)siloxane copolymer having the following chemical structure:
(R₂R″SiO_{1/2})₂(RR′SiO_{2/2})ₘ(R₂SiO_{2/2})ₙ (where R=R″=methyl, R′=HS(CH₂)₂CH₂—, and on average, n=43 and m=5)

The following condensation reaction catalysts were used as component (C).
(c1): titanium ethyl acetoacetate complex mixed with a methyl-trimethoxy silane
(c2): titanium ethyl acetoacetate complex
(c3): tetra-n-butyl titanate
(c4): tetra-t-butyl titanate

The following photoinitiators were used as component (D).
(d1): 2,4,6-trimethylbenzoylphenyl phosphinate
(d2): bis(2,4,6-trimethylbenzoyl)-phenylphosphine oxide
(d3): 2,2-dimethoxy-1,2-diphenylethan-1-one
(d4): 2-hydroxy-2-methylpropiophenone
(d5): 2,4,6-trimethylbenzoyldiphenyl phosphinate

The following silanes were used as component (E).
(e1): methyltrimethoxysilane
(e2): dimethyldimethoxysilane
(e3): dimethyldiethoxysilane

The following radical scavengers were used as component (F).
(f1): butylated hydroxytoluene
(f2): N-nitroso-N-phenylhydroxylamine aluminium salt

The following was used as component “filler”: hexamethyldisilazane treated fumed silica.

The following was used as component “adhesion promoter”: aminopropyltrimethoxysilane Reaction with glycidoxypropyltrimethoxysilane and methyltrimethoxysilane.

The following was used as component “silicone resin”: silicic acid, sodium salt, reaction products with chlorotrimethylsilane.

TABLE 1

| | | | | | | | | | | | | Practical | |
|---|---|---|---|---|---|---|---|---|---|---|---|---|---|
| | | | Comparative Examples | | | | | | | | | Examples | |
| | | | 1 | 2 | 3 | 4 | 5 | 6 | 7 | 8 | 9 | 1 | 2 |
| dual cure | (A) | (a1) | 100 | 100 | 100 | 100 | 100 | 100 | 100 | 100 | 100 | 100 | 100 |
| organopolysiloxane | (B) | (b1) | 9.51 | 9.17 | 11.49 | 8.17 | 8.21 | 8.63 | 8.25 | 8.20 | 10.79 | 8.25 | 8.20 |
| composition | (C) | (c2) | 0.79 | 0.71 | 1.71 | 0.73 | 1.55 | 0.88 | 0.74 | 1.14 | 1.29 | 0.74 | 1.14 |
| (parts by | (D) | (d1) | — | — | — | — | — | 0.50 | 0.37 | 0.34 | 0.40 | 0.37 | 0.34 |
| mass) | | (d2) | — | — | — | 0.24 | 0.59 | 0.13 | 0.27 | 0.17 | 0.08 | 0.25 | 0.17 |
| | | (d3) | — | 1.19 | 1.37 | — | — | — | — | — | 0.64 | 0.86 | 0.57 |
| | | (d4) | — | — | — | 0.73 | — | — | 0.86 | 0.57 | | — | — |
| | | (d5) | 0.58 | — | — | — | — | — | — | — | — | — | — |
| | (E) | (e1) | — | — | 2.62 | — | 3.57 | 4.38 | — | 3.42 | 2.09 | — | 3.42 |
| | | (e2) | 0.79 | 0.95 | — | 0.85 | — | — | 0.86 | — | — | 0.86 | — |
| | | (e3) | 5.24 | 3.93 | — | 5.00 | — | — | 5.05 | — | — | 5.05 | — |
| | (F) | (f1) | 0.04 | 0.04 | 0.04 | 0.04 | 0.04 | 0.04 | 0.04 | 0.03 | 0.05 | 0.04 | 0.03 |
| | | or | (*) | (f1) | (f1) | (f1) | (f1) | (f1) | (f1) | (f1) | (f1) | (f1) | (f1) |
| | | (f2) | | | | | | | | | | | |

| | | | | | | | | | | | | | |
|---|---|---|---|---|---|---|---|---|---|---|---|---|---|
| | | Filler | 14.37 | 3.05 | 7.63 | 6.20 | 4.99 | 10.56 | 6.68 | — | 5.46 | 6.68 | — |
| | | Silicone | — | — | — | — | — | — | — | — | 40.27 | — | — |
| | | resin | | | | | | | | | | | |
| UV | Fresh | 405 nm | Cured | No | No | Cured | Cured | Cured | Cured | Cured | Cured | Cured | Cured |
| exposure | | | | cure | cure | | | | | | | | |
| | | Additional | — | Surface | Surface | Cured | — | — | Cured | Cured | Cured | Cured | Cured |
| | | 365 nm | | cured | cured | | | | | | | | |
| | 14 days | 405 nm | No | No | No | Partial | Cured | Partial | Partial | No | No | cured, | cured, |
| | aging | | cure | cure | cure | cure- | | cure, | cure, | cure | cure | wet | wet |
| | | | | | | gel | | wet | wet | | | surface | surface |
| | | | | | | | | surface | surface | | | | |
| | | Additional | — | Surface | Surface | — | — | — | Cured | No | Cured | Cured | Cured |
| | | 365 nm | | cured | cured | | | | | cure | (low | | |
| | | | | | | | | | | | deep | | |
| | | | | | | | | | | | cure) | | |

| Skin over | Fresh | 1 | 1 | 1 | 1 | 1 | 1 | 1 | 1 | 1 | 1 | 1 |
|---|---|---|---|---|---|---|---|---|---|---|---|---|
| time (hr) | 14 days | 2 | 20 | 1 | >24 | 1 | 1 | >24 | 1 | 1 | 4 | 1 |
| | aging | | | | | | | | | | | |

(*) mixture of components (f1) and (f2) in mass ratio of (f1)/(f2) = 83/17

TABLE 2

| | | | Comparative | Practical Examples | | | |
|---|---|---|---|---|---|---|---|
| | | | Example 1 | 3 | 4 | 5 | 6 |
| dual cure | (A) | (a1) | 100 | 100 | 100 | 100 | 100 |
| organopolysiloxane | (B) | (b1) | 9.51 | 9.63 | 9.66 | 4.11 | 9.60 |
| composition | (C) | (c2) | 0.79 | 0.52 | 0.78 | 1.07 | 0.80 |
| (parts | (D) | (d1) | — | 0.39 | 0.39 | 0.54 | 0.39 |
| by mass) | | (d2) | — | 0.19 | 0.19 | 0.27 | 0.19 |
| | | (d3) | — | 0.65 | 0.65 | 0.89 | 0.64 |
| | | (d5) | 0.58 | — | — | — | — |
| | (E) | (e1) | — | 3.49 | 3.57 | 4.92 | — |
| | | (e2) | 0.79 | — | — | — | 2.06 |
| | | (e3) | 5.24 | — | — | — | 2.57 |
| | (F) | (f1) and (f2) mass ratio: | 0.04 | 0.05 | 0.05 | 0.06 | 0.05 |
| | | (f1)/(f2) = 83/17 | | | | | |

| | | Filler | 14.37 | 14.40 | 14.40 | 5.28 | 12.00 |
|---|---|---|---|---|---|---|---|
| | | Silicone resin | — | — | — | 60.82 | — |
| | | Adhesion promoter | — | — | — | 0.90 | — |
| UV cure | Fresh | 405 nm | Cured | Cured | Cured | Cured, wet | Cured |
| state after | | | | | | surface | |
| UV | | 395 nm | — | Cured | Cured | Cured, wet | Cured |
| irradiation | | | | | | surface | |
| | | Additional | — | Same surface feature | | | |
| | | 365 nm | | as 405 or 395 nm exposure | | | |
| | 14 days | 405 nm | No cure | Cured, | Cured, | Cured, wet | Cured, |
| | aging | | | tack | tack | surface | high-tack |
| | | 395 nm | — | Cured, | Cured, | Cured, wet | Cured, |
| | | | | tack | tack | surface | high-tack |
| | | Additional | — | Changed to dry | | Same as | Cured, |
| | | 365 nm | | surface after 365 | | above | less tack |
| | | | | nm exposure | | | |
| In-depth | Fresh | 405 nm | >7 mm | >7 mm | >7 mm | n/a | >7 mm |
| cure after | | 395 nm | — | >7 mm | >7 mm | n/a | — |
| UV | 14 days | 405 nm | No cure | >7 mm | >7 mm | n/a | 6.1 mm |
| irradiation | aging | 395 nm | — | 7.0 mm | 6.3 mm | n/a | n/a |
| Moisture | Fresh | | 30 | 40 | 40 | 60 | 30 |
| cure - | 14 days | | 120 | 150 | 50 | 150 | 300 |
| Skin over | aging | | | | | | |
| time (min) | | | | | | | |
| Shore A | Fresh | UV 405 nm only | 22 | 23 | 23 | n/a | 22 |
| Hardness | | UV + moisture cure (3 days) | 34 | 39 | 39 | n/a | 32 |
| | 14 days | UV 405 nm only | No cure | 19 | 17 | n/a | 14 |
| | aging | UV + moisture cure (3 days) | 13 | 35 | 35 | n/a | 24 |
| | Change (UV and moisture) | | −62% | −10% | −10% | — | −25% |
| Viscosity | Fresh | | 11430 | 14843 | 13970 | 859 | 17264 |
| | 14 days | | 11748 | 13295 | 12889 | 845 | 15320 |
| | aging | | | | | | |
| | Change | | 2.8% | −10.4% | −7.7% | −1.6% | −11.3% |

### INDUSTRIAL APPLICABILITY

The dual curable organopolysiloxane composition according to this disclosure can be cured both photo-cure and cure through exposure to moisture, and exhibits good to excellent curability and long-term storage stability at room temperature or ambient storage condition. Furthermore, the composition according to this disclosure can be easily applied in “solventless-type” composition form having excellent coating ability and appropriate viscosity. Therefore, the present composition can be used as a potting composition, coating, adhesive, encapsulation.

1. A dual cure organopolysiloxane composition comprising:
(A) an organopolysiloxane having an average of one or more alkenyl group(s) per molecule and an average of one or more hydrolysable group(s) per molecule;
(B) an organopolysiloxane having an average of two or more photoreactive groups per molecule;
(C) a condensation reaction catalyst;
(D) a combination of the following photoinitiators (d1) to (d3);
(d1) 2,4,6-trimethylbenzoylphenyl phosphinate,
(d2) bis(2,4,6-trimethylbenzoyl)-phenylphosphine oxide, and
(d3) 2,2-dimethoxy-1,2-diphenylethan-1-one;
(E) a silane with an average of two or more hydrolysable groups per molecule; and, optionally,
(F) a radical scavenger.

2. The dual cure organopolysiloxane composition according to claim 1, wherein the mass ratio for each of components (d1) to (d3) is within the following ranges when the total mass of component (d1) to (d3) is 100% by mass:
the mass ratio for component (d1) ranges from 10 to 30 mass % by mass,
the mass ratio for component (d2) ranges from 20 to 40 mass % by mass, and
the mass ratio for component (d3) ranges from 40 to 80 mass % by mass.

3. The dual cure organopolysiloxane composition according to claim 1, wherein the composition results from both a UV-radical cure mechanism and a moisture cure mechanism.

4. The dual cure organopolysiloxane composition according to claim 1, wherein the composition is substantively free or free from organic solvents.

5. The dual cure organopolysiloxane composition according to claim 1, suitable for use as a potting composition, a coating, an adhesive, and/or an encapsulation or encapsulant.
